(19) United States
(12) Patent Application Publication
(10) Pub. No.: US 2015/0130754 A1
(43) Pub. Date: May 14, 2015

(54) TOUCH SENSOR

(71) Applicant: Tactus Technology, Inc., Fremont, CA (US)

(72) Inventors: Micah B. Yairi, San Carlos, CA (US); Todd A. Culver, Orlando, FL (US); Craig M Ciesla, Mountain, CA (US)

(21) Appl. No.: 14/498,659

(22) Filed: Sep. 26, 2014

Related U.S. Application Data
(60) Provisional application No. 61/883,159, filed on Sep. 26, 2013.

(51) Int. Cl. G06F 3/041; G06F 3/01; G06F 3/044

(52) U.S. Cl. CPC G06F 3/0416; G06F 3/044; G06F 3/016
USPC 345/174

(57) ABSTRACT

A touch sensor including a sheet defining a surface and enclosing a set of channels, each channel in the set of channels isolated from other channels in the set of channels and defining a variable width; a set of distinct volumes of electrically-conductive fluid contained within the set of channels; a set of electrodes electrically coupled to the set of distinct volumes of electrically-conductive fluid; and a controller electrically coupled to the set of electrodes, applying a voltage to a subset of the set of distinct volumes of electrically-conductive fluid contained in a subset of channels in the set of channels via a subset of the set of electrodes; and approximating a position of an input over the surface based on a change in voltage.

### CROSS-REFERENCE TO RELATED APPLICATIONS

This application claims the benefit of U.S. Provisional Application No. 61/883,159, filed on 26 Sep. 2013, which is incorporated in its entirety by this reference.

This application is related to U.S. patent application Ser. No. 14/317,685, filed on 27 Jun. 2014, which is incorporated in its entirety by this reference.

### TECHNICAL FIELD

This invention relates generally to tactile user interfaces, and more specifically to a touch sensor in the user interface field.

### BRIEF DESCRIPTION OF THE FIGURES

FIG. 1 is a schematic representation of a touch sensor of one embodiment of the invention;

FIG. 2 is a schematic representation of one variation of the touch sensor;

FIGS. 3A, 3B, and 3C are schematic representations of variations of the touch sensor;

FIG. 4 is a schematic representation of one variation of the touch sensor;

FIG. 5 is a schematic representation of one variation of the touch sensor;

FIGS. 6A and 6B are schematic representations of one variation of the touch sensor implementation a user interface;

FIG. 7 is a schematic representation of one variation of the touch sensor;

FIGS. 8A, 8B, and 8C are schematic representations of one variation of the touch sensor; and

FIGS. 9A and 9B are schematic representations of one variation of the touch sensor.

### DESCRIPTION OF THE EMBODIMENTS

The following description of the embodiments of the invention is not intended to limit the invention to these embodiments, but rather to enable any person skilled in the art to make and use this invention.

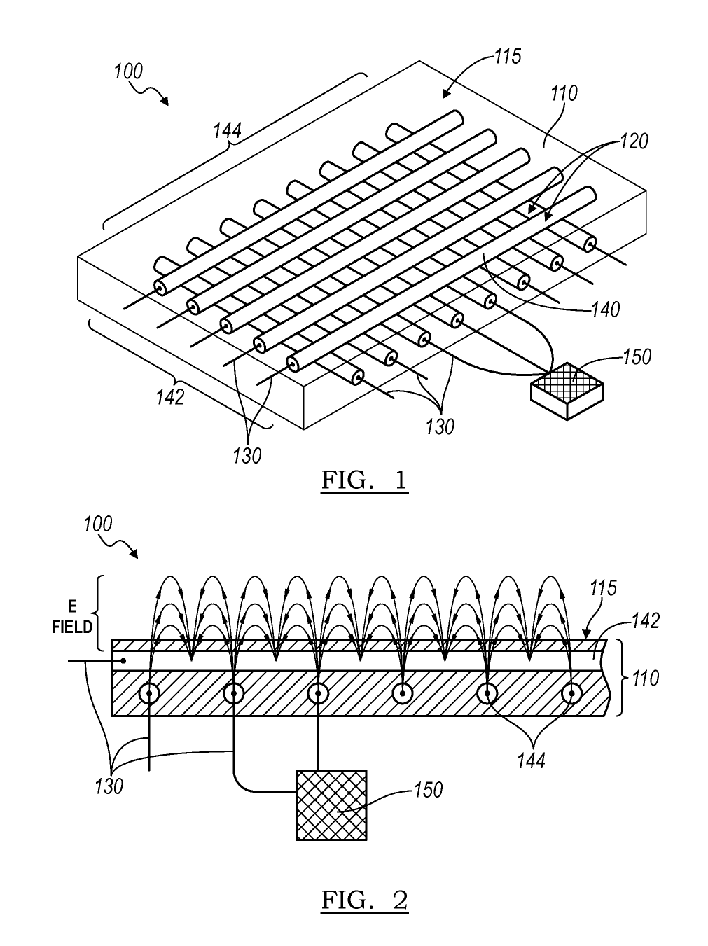

As shown in FIG. 1, a touch sensor 100 includes a sheet 110 defining a surface 115 and enclosing a set of channels, each channel 140 in the set of channels isolated from other channels in the set of channels and defining a variable width; a set of distinct volumes of electrically-conductive fluid 120 contained within the set of channels; a set of electrodes 130 electrically coupled to the set of distinct volumes of electrically-conductive fluid 120; and a controller 150 electrically coupled to the set of electrodes 130, applying a voltage to a subset of the set of distinct volumes of electrically-conductive fluid 120 contained in a subset of channels in the set of channels via a subset of the set of electrodes 130; and approximating a position of an input over the surface 115 based on a change in voltage.

A variation of the touch sensor 100 includes a sheet 110 defining a surface 115 and enclosing a set of channels, each channel 140 in the set of channels distinct from other channels in the set of channels and including a series of cavities of first width interposed between neck sections of a second width less than the first width, a projection of a first subset of channels in the set of channels onto the surface 115 intersecting a projection of a second subset of channels 144 in the set of channels onto the surface 115; a set of distinct volumes of electrically-conductive fluid 120 contained within the set of channels, fluid contained within a cavity 148 of a channel 140 in the first subset of channels capacitively coupled to fluid contained within a cavity 148 of a channel 140 in the second subset of channels 144; and a set of electrodes 130, an electrode in the set of electrodes 130 electrically coupled a distinct volume of electrically-conductive fluid 120 in the set of distinct volumes of electrically-conductive fluid 120.

Another variation of the touch sensor 100 can include a sheet 110 defining a surface 115, a first array of channels; and a second array of channels, the sheet 110 enclosing channels in the first array of channels at a first depth below the surface 115, the sheet 110 enclosing channels in the second array of channels at a second depth from the surface 115 greater than the first depth, a projection of the first array of channels onto the surface 115 intersecting a projection of the second array of channels onto the surface 115; a first set of discrete volumes of electrically-conductive fluid 120, a discrete volume of electrically-conductive fluid 120 in the first set of volumes of electrically-conductive fluid 120 contained within a channel 140 in the first array of channels; a second set of discrete volumes of electrically-conductive fluid 120, a discrete volume of electrically-conductive fluid 120 in the second set of volumes of electrically-conductive fluid 120 contained within a channel 140 in the second array of channels; a first set of electrodes 130, an electrode in the first set of electrodes 130 electrically coupled to a discrete volume of electrically-conductive fluid 120 in the first set of volumes of electrically-conductive fluid 120, the first set of electrodes 130 communicating electrical current into the first set of discrete volumes of electrically-conductive fluid 120; a second set of electrodes 130, an electrode in the second set of electrodes 130 electrically coupled to a discrete volume of electrically-conductive fluid 120 in the second set of volumes of electrically-conductive fluid 120, the second set of electrodes 130 communicating electrical current into the second set of discrete volumes of electrically-conductive fluid 120, the first set of discrete volumes of electrically-conductive fluid 120 capacitively coupled to the second set of discrete volumes of electrically-conductive fluid 120.

### 1. Applications

Generally, the touch sensor 100 can define a capacitive touch sensor that implements arrays of fluid channels containing conductive fluid in order to generate an electric field across a portion of the surface 115 and to capture changes in the electric field across the portion of the surface 115 due to the proximity of a foreign object, such as a finger or stylus, to the surface 115. For example, the touch sensor 100 can function as a projected capacitive touch sensor, wherein the first and second fluid arrays can be filled with conductive fluid to define a conductive grid across a portion of the layer, and wherein the set of electrodes 130 maintains a voltage potential between fluid channels in the first array and fluid channels in the second array to induce measurable capacitance between fluid channels of different arrays. Generally, the presence of a finger, stylus, or other foreign object proximal the surface 115 changes the capacitance between local portions of fluid channels in the first and second channel arrays 142, 144. This change in mutual capacitance can then be communicated via the electrodes 130 to a touch sensor controller 150, processor, and/or conditioning circuit that correlates the local change in mutual capacitance with both the presence and location of the foreign object on or proximal the surface 115.

A variation of the touch sensor 100 includes a surface capacitive touch sensor that includes a single array of fluid channels that generate a substantially uniform electrostatic field across the layer. In this variation, a conductor, such as a finger or a stylus, proximal or in contact with a portion of the surface 115 forms a capacitor with one or more fluid channels in the array of fluid channels. Capacitance across the channel(s) and the conductor can then be communicated via the electrodes 130 to a controller 150, processor, and/or conditioning circuit that correlates a local change in the electric field across the layer with both the presence and location of the conductor on or proximal the surface 115. However, the touch sensor 100 can function in any other way and as any other suitable type of capacitive touch sensor.

In one example application of the touch sensor 100, the touch sensor 100 implements mutual capacitance to detect contact by an input object at the surface 115 of the sheet 110. In this example application, a first (receiver) electrode couples to a first channel 140 in the first subset of channels filled with electrically conductive fluid and formed below the surface 115 of a PMMA sheet 110, thereby defining a receiver channel. A second (transmitter) electrode couples to a second channel in the second subset of channels 144, thereby defining a transmitter channel. The first subset of channels can define an electric field capacitively coupling a cavernous spike 149 in line with and fluidly coupled to the first channel 140 with a second cavernous spike 149 in line with and fluidly coupled to the second channel 140. The channels of the first subset of channels are interwoven with the channels of the second subset of channels 144. A controller 150 electrically coupled to the first and second electrode applies a voltage pulse to the first channel 140 via the first (transmitter) electrode, records the discharge time of the voltage pulse through the second channel 140 with the second (receiver) electrode. When an input object, such as a finger, contacts the surface 115 of the sheet no, the voltage pulse discharges through the spike 149 and into the input object, thereby shortening the detected discharge time of the voltage pulse at the second electrode. The controller 150 can, thus, approximate the position of the input object based on the discharge time of the voltage pulse and the relative location of the first and second electrode.

In another example application of the touch sensor 100, the touch sensor 100 implements a self-capacitance measurement method to detect contact by the input object at the surface 115 of the sheet 110 by detecting the capacitive load at an electrode relative to a grounded electrode. In this example application, a transparent sheet 110 mounted over a display of a computing device includes a first subset of parallel channels with circular cross-sections at a first depth below the surface 115 of the transparent sheet 110. The sheet 110 also defines a second subset of parallel channels, which are perpendicular to the first subset of parallel channels with circular cross-sections at a second depth below the surface 115 of the transparent sheet 110, the second depth greater than the first depth. The channels of the first subset and second subset of parallel channels are filled with an electrically-conductive mixture of mineral oil and indium tin oxide (ITO) particulate. Each channel 140 in the first subset and second subset of parallel channels couples to an electrode 130. The electrodes coupled to the first subset of parallel channels form a first array of electrodes iso; the electrodes 130 coupled to the second subset of parallel channels form a second array of electrodes 130. A controller 150 electrically coupled to the electrodes 130 applies a voltage to each electrode sequentially across each array of electrodes. The controller 150 applies a voltage to a first electrode at a first position, then to a second electrode adjacent the first electrode, then to a third electrode adjacent the second electrode, and so forth until the controller 150 has applied voltage to each and every electrode in the array of electrodes 130. The controller 150 applies voltages first to the first array of electrodes 130 and then to the second array of electrodes 130. Additionally, the controller 150 detects and records a time of capacitive decay of the voltage associated with each electrode from the voltage applied initially by the controller 150 to a threshold voltage. When an input object, such as finger, contacts or is proximal to the surface 115 of the sheet 110, a portion of the voltage applied to an electrode discharges through the input object, thereby shortening the time of capacitive decay from the voltage applied initially by the controller 150 to the threshold voltage. The controller 150 can approximate the position of the contact by the input object by detecting which electrode(s) are associated with the shortened time of capacitive decay. The first array of electrodes 130 can define an X-axis. Thus, when the controller 150 detects shortened time of capacitive decay at a particular electrode in the first array of electrodes 130, the controller 150 correlates the particular electrode with an X-coordinate associated with the position of the input object. Likewise, the second array of electrodes 130 can define a Y-axis and, thus, the controller 150 can correlate shortened capacitive decay at a particular electrode in the second array of electrodes 130 with a Y-coordinate associated with the position of the input object.

The touch sensor 100 can function to define a flexible touch sensitive surface 115, which can be arranged over, substantially around, or below an object or three-dimensional surface. Furthermore, the touch sensor 100 can deform, flex, morph, contort, etc. dynamically. For example, the touch sensor 100 can be arranged circumferential about a flexible (and compressible) sphere (e.g., a rubber ball). The touch sensor 100 can deform as the flexible sphere deforms since the touch sensor 100 includes channels filled with conductive fluid, which can flex better than touch sensors including brittle, plated, and substantially rigid materials, such as indium tin oxide.

The sheet 110 and the fluid can be substantially transparent or translucent, such that the touch sensor 100 can be applied over a display to enable touchscreen functionality, such as for integration in a smartphone, a tablet, a television, a personal music player, a personal data assistant (PDA), a watch, an in-dash vehicle display, or any other suitable input device including a display. The layer and/or fluid can also be substantially opaque such that the touch sensor 100 can be applied to input devices without displays, such as a gaming controller 150, a television remote control, a door or safe keypad, or a peripheral keyboard.

### 2. Sheet

As shown in FIG. 1, the touch sensor 100 includes a sheet 110, which defines a surface 115 and encloses a set of channels, each channel 140 in the set of channels isolated from other channels in the set of channels and defining a variable width. Generally, the sheet 110 functions to define a touch-sensitive surface 115 with integrated channels filled with electrically-conductive fluid 120, the touch sensitive surface defining an interface with which a user can interact. The sheet 110 can be mounted over a display, a computing device, or any other surface 115 and define an input surface 115 through which the controller 150 can detect an input at the surface 115 by an input object.

The sheet 110 can be of uniform thickness across the surface 115 with the channels integrated (e.g., buried, molded, etc.) within the sheet 110. Each channel 140 can be substantially linear and defined at a constant depth within the layer. Alternatively, each channel 140 can be curved or include otherwise nonlinear sections. Furthermore, each channel 140 can be defined within the layer at varying depth along the length of the channel 140. The channels can be of uniform cross-sections, such as square, circular, rectilinear, or rectilinear with filleted or chamfered corners. Alternatively, the channels can be of non-uniform or varying cross-sections along the length of the channel 140. Thus, the width of the channel can vary along the length of the channel. For example, a channel 140 can define a neck, such that the inner diameter of the channel 140 at the neck is less than the inner diameter of the channel 140 elsewhere along the length of the channel 140. By varying the width of the channel, the touch sensor can implement an electrically-conductive element with high and varying resistance along the length of the channel. However, the sheet 110 can define fluid channel 140 of any other form or geometry.

In one implementation of the touch sensor 100, the sheet 110 can enclose a first subset of channels in the set of channels at a first depth below the surface 115, the first subset of channels defining a first linear array. Additionally or alternatively, the sheet 110 can enclose a second subset of channels 144 in the set of channels at a second depth below the surface 115 greater than first depth, the second subset of channels 144 defining a second linear array. In this implementation, the channels of the first subset of channels can be substantially parallel. Likewise, the channels of the second subset of channels 144 can be substantially parallel. In this implementation, the channels of the first subset of channels can be nonparallel with the channels of the second subset of channels 144. For example, the channels of the first subset of channels can be perpendicular with or form acute angles with the channels of the second subset of channels 144. Alternatively, the channels within the first and/or second linear array can be nonparallel. For example, the sheet 110 can define one array of channels with varying horizontal and vertical center-to-center distances, or the sheet 110 can define an other array of concentric rings of channels. Channels in each subset of channels can be of a cross-section profile (e.g., varying along the length of the channel 140), such that all of the channels within each subset of channels share the cross-section profile. For example, channels in the first subset of channels can share a substantially circular cross-section. Alternatively, each channel 140 in each subset of channels can be of an independent cross-section profile, such that the cross-section of a channel 140 in the first subset of channels can be independent (i.e., different) from other channels in the subset of channels. For example, a channel 140 in the second subset of channels 144 can be of a non-uniform cross-section that varies along the length of the channel 140. A second channel and a third channel can be of a uniform, substantially rectangular cross-section. A fourth channel can be of a uniform, substantially circular cross-section. In another example, each channel in the first subset of channels can neck proximal a region of the channel that bisects or crosses over a channel in the second subset of channels 144. Generally, each channel can be distinct from other channels such that the volume of conductive fluid in each channel 140 is isolated from the volumes of conductive fluid in all other channels defined within the sheet 110. However, the sheet 110 can define channels of any other form, geometry, or intersection.

In one example of the foregoing implementation of the touch sensor 100, the channels in the first subset of channels and the second subset of channels 144 are of substantially uniform cross-section, are linear along the lengths of the channels, and are defined within the sheet 110 at constant depth, wherein the channels in the first subset of channels can be defined at a shallower depth (i.e., closer to an exposed surface of the sheet 110) within the layer than the channels of the second subset of channels 144. This example can yield an electric field across a channel 140 in the first subset of channels and bisecting channels in the second subset of channels 144, as shown in FIG. 2.

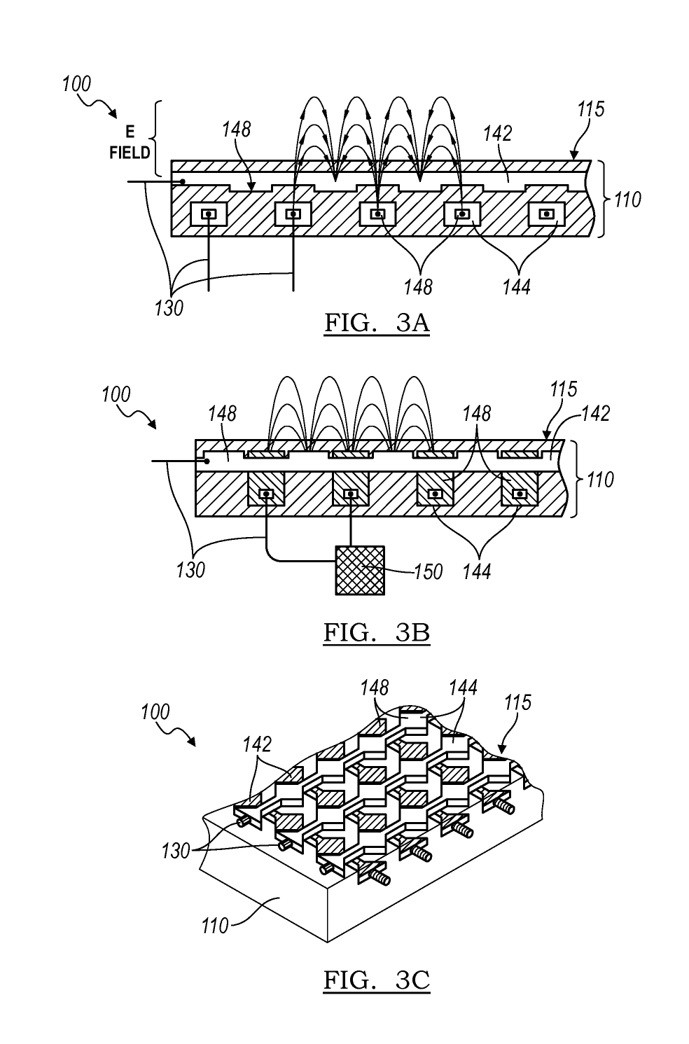

In another example of the foregoing implementation of the touch sensor 100, the channels in the first and second subsets of channels can be linear along the lengths of the channels and the channels of the first subset of channels can be perpendicular to the channels of the second subset of channels 144. Each channel 140 in the first subset of channels can bisect (but not intersect) at least one channel 140 in the second subset of channels 144 at a junction. Each channel 140 in the set of channels can include a series of cavities of a first width interposed between neck sections of a second width less than the first width. The sheet 110 can define a neck in each channel 140 proximal each junction. Furthermore, the sheet 110 can define a cavity 148 in line with each channel 140 on one or both sides of each junction. For example, at a junction proximal an end of the channel 140, the sheet 110 can define a single cavity 148 on an interior side of the junction (i.e., opposite the end of the channel 140). The cavities can define non-overlapping pads (i.e., pad-shaped cavities) on each side of each junction, as shown in FIG. 3C, wherein each pad 147 functions as a plate of a capacitor. Likewise, the narrow neck portion, which is highly resistive, can act as an insulating layer between the plates of the capacitor. Mutual capacitance between pads of two or more distinct channels can be monitored to detect the presence of a foreign object on or adjacent the surface 115. In one example implementation, the cavities in line with the channels in the second (i.e., lower) subset of channels can be defined at a depth greater than the top surfaces of the cavities corresponding to the first subset of channels. In this implementation, the touch sensor 100 can yield an electric field across a pad 147 of a channel 140 in the first subset of channels and a pad 147 of a bisecting channel 140 in the second subset of channels 144, as shown in FIG. 3A.

In another implementation, the sheet 110 can define cavities defining a first set of planar faces adjacent and offset from the surface 115 and cavities defining a second set of planar faces substantially in plane with the first set of planar faces. Generally, the sheet 110 can define top surfaces of the cavities corresponding to the channels in the first (i.e., upper) subset of channels planar to top surfaces of cavities corresponding to the channels of the second (i.e., lower) subset of channels. In this implementation, the touch sensor 100 can yield an electric field across a pad 147 of a channel 140 in the first subset of channels and a pad 147 of a bisecting channel 140 in the second subset of channels 144, as shown in FIG. 3B. In these or other example implementations, the cavities (and pads) can be cubic, rectilinear, spherical, hemispherical, tetrahedral, or of any other suitable shape and form. Similarly, as shown in FIG. 7, the channels can define spikes (i.e., spike shaped cavities) additionally or alternatively to pads. The spikes can cooperate to focus an electric field to particular regions of the surface 115 of the sheet 110. Touch sensor 100 sensitivity can, thus, be set in the geometry of the channel 140, the array, and the cavity 148.

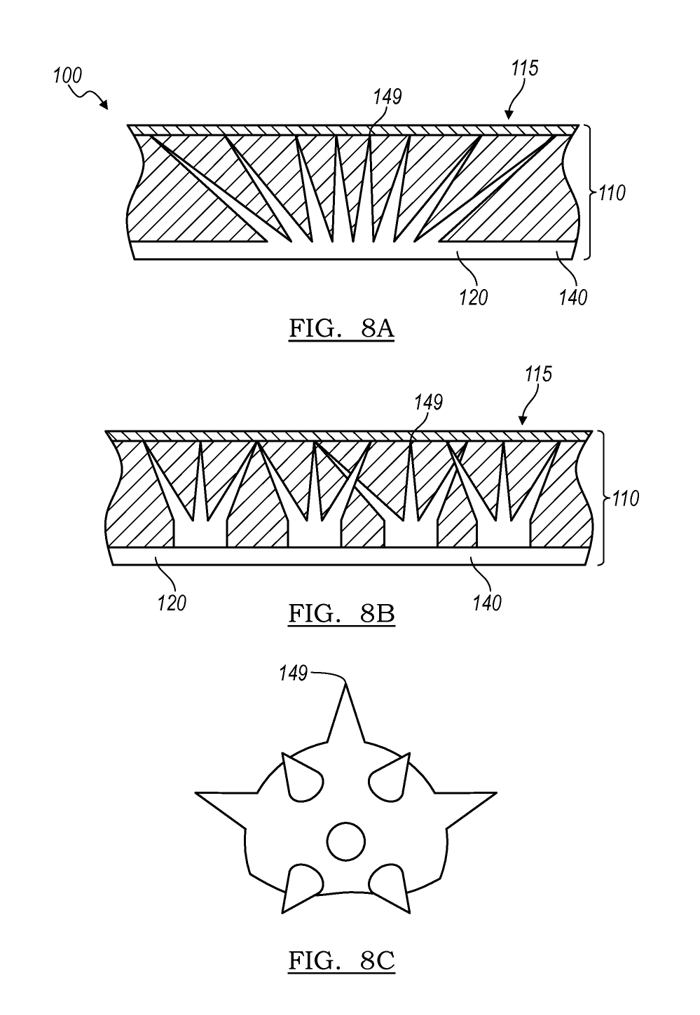

In a similar implementation shown in FIG. 7, the sheet 110 can define cavities in the form of spikes projecting from a channel 140 offset a particular depth below the surface 115 substantially upward toward the surface 115. In one example implementation, the spikes can extend upward substantially perpendicular to the surface 115 and normal to a channel 140 defined parallel to the surface 115. Alternatively, in another example implementation, the spikes can extend upward from the channel 140 at an acute angle to the channel 140 and the surface 115. Thus, the sheet no can define directional spikes, as shown in FIG. 8A. The directional spikes can function to increase a sensible volume over the sheet and to focus (directional) capacitive coupling over particular regions of the surface 115. For example, the spikes can be angled (i.e., pointed) toward a bezel around a periphery of the touch sensor in order to enable detection of inputs on the bezel even though no portion of the channels of the touch sensor 100 are arranged under the bezel. Furthermore, the sheet 110 can define multiple spikes extending from a opening in the channel 140, each spike 149 extending at a different acute angle toward the surface 115, as shown in FIGS. 8A, 8B, and 8C. The spikes can extend at acute angles within a single plane or can form a three-dimensional mace-like configuration of spikes, such as shown in FIG. 8C. In this implementation, the spikes can focus the electric-field upward (and perpendicular) to the surface 115 to improve local sensitivity to objects near the spikes. The spikes can extend such that a spike extending from one channel 140 crosses or intersects a spike 149 extending from a second opening the channel 140 or from another adjacent channel, as shown in FIGS. 8B and 8C.

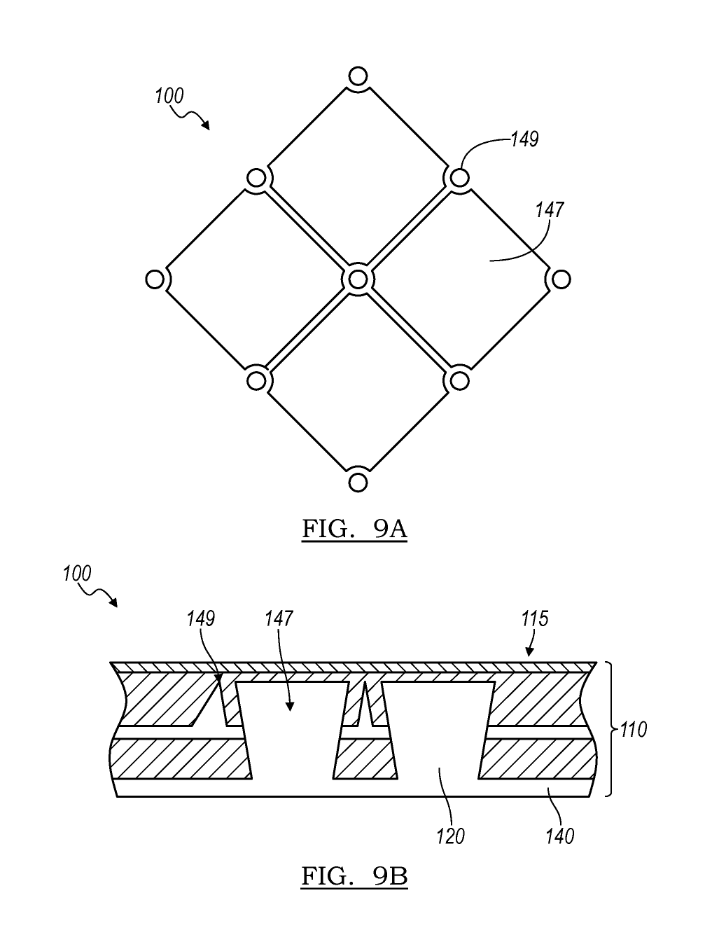

In an example of the foregoing implementation shown in FIGS. 9A and 9B, the sheet 110 can define the first subset of channels with cavities in the form of spikes and the second subset of channels 144 with cavities in the form of substantially rectangular pads. The spikes and the pads can be interleaved to balance increased size of the area of the electric field suitable for detecting an input with heightened sensitivity through concentration of conductive material. Thus, the spikes function to increase touch sensor 100 sensitivity by concentrate electrically-conductive fluid 120 at a point adjacent the surface 115 and the pads function to increase the area for detecting an input.

In a similar implementation, the first subset of channels can include cavities interleaved between cavities of the second subset of channels 144. Generally, in this implementation, a cavity 148 of the first subset of channels can be capacitively coupled to the cavities of the second subset of channels 144 that are adjacent the cavity 148 of the first subset of channels, thereby generating a electric field coupling a channel 140 of the first subset of channels with one or more channels of the second subset of channels 144. Thus, when the controller 150 applies a voltage pulse to the first subset of channels, the voltage pulse can discharge through the cavity 148 of the first subset of channels and through the channels of the second subset of channel 140 that are capacitively coupled to the cavity 148 of the first subset of channels through the adjacent cavities of the second subset of channels 144. The first subset of channels can further define neck sections arranged over neck sections of the second subset of channels 144, such that the neck section of the first subset of channels are interleaved with neck section of the second subset of channels 144. In this implementation, the neck sections, which are of high resistivity, can function to focus the electric field to the cavities.

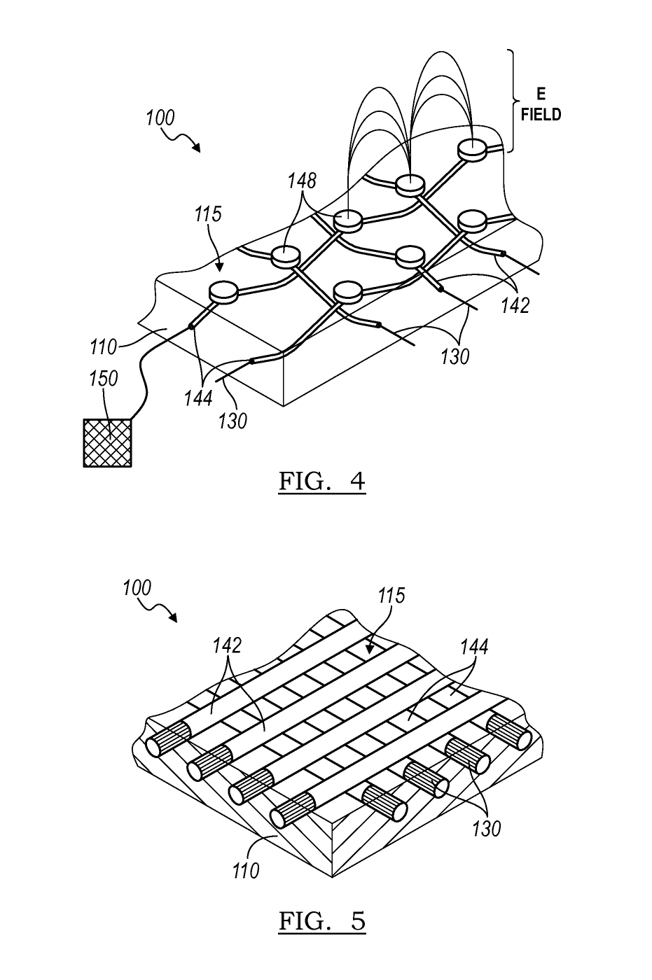

In another implementation, the sheet 110 can define undulating channels at varying (e.g., oscillatory) depths within the sheet 110 with channels in the first subset of channels perpendicular to channels in the second subset of channels 144. Thus, the first and second subsets of channels can define a mesh or woven pattern of channels through the sheet 110, as shown in FIG. 4. For each channel 140, the sheet 110 can further define a cavity 148 inline with the channel 140 and proximal a portion of the channel 140 nearest the surface 115. In this example implementation, each cavity 148 can define a pad 147, wherein adjacent pads inline with distinct channels can yield electric fields, as shown in FIG. 4.

However, the sheet 110 can define channels of the first and second subset of channels 142, 144 according to any other form or geometry and can define any number and geometry of cavities and pads inline with one or more channels. Generally, the sheet 110 can define a pattern of channels that mimic any suitable pattern of conductive material in common, realized, or theoretical capacitive touch sensors, such as for capacitive touchscreens.

The sheet 110 can be substantially rigid, such as composed of glass, or substantially elastic or flexible, such as composed of silicone or urethane. The sheet 110 can be of an electrically insulated material, such that voltage pulse conducted through the electrically-conductive fluid 120 within a channel 140 can be substantially isolated within the channel 140 and resist conduction through the sheet 110. However, the channel 140 can be capacitively coupled to other channels through the cavities. The sheet 110 can be planar and arranged over a substantially planar (and rigid) display. Alternatively, the sheet 110 can be curved or otherwise non-planar and arranged over a curved or non-planar display. The sheet 110 can also be of elastic material, such that the sheet 110 can be substantially flexible across the surface 115. An elastic sheet 110 can be arranged over a planar surface (e.g., a planar display), a curved surface with a planar-curve cross-section (e.g., a non-planar display), or can be stretched across or otherwise applied to a three-dimensional curved surface. The sheet 110 can also be composed of multiple materials, such as a stack of sublayer, including a Polyehthylene Terephthalate Glycol (PETG) sublayer backed by one or more silicone, urethane, and/or polycarbonate sublayers. The sheet 110 can be manipulated into various shapes or configurations. For example, the layer can be rolled, unrolled, and/or twisted.

In a similar implementation, the sheet 110 can include a substrate, a first cover layer defining the surface 115 and arranged over a first face of the substrate to enclose a first subset of channels in the set of channels and a second cover layer arranged over a second face of the substrate opposite the first face to enclose a second subset of channels 144 in the set of channels.

In one example of the foregoing implementation, the sheet 110 can include a stack of two PETG layers that sandwich a silicone substrate. One of the PETG layers can be etched to define upper portions of the first and second subsets of channels and the second PETG layer can be etched to define lower portions of the first and second subsets of channels. The silicone substrate can define bored holes. The PETG layers can be bonded to each side of a silicone substrate such that the bored holes of the silicone substrate align with the etched upper and lower portions of the first and second subsets of channels. The bonded PETG layers and intermediate silicone substrate form the sheet 110, which is a unitary structure including the surface 115, a first subsets of channels, and a second subset of channels 144. Alternatively, the silicone substrate can define a continuous sheet 110 without perforations, such as the bored holes.

In another example of the foregoing implementation, the sheet 110 can include a stack of three glass layers. A first glass layer can be etched to define upper portions of the first and second subset of channels 142, 144, and a third glass layer can be etched to define the lower portions of the first and second subsets of channels 142, 144. A second glass layer can be etched to define the (vertical) junctions between the upper and lower portions of each channel 140 in the first and second subsets of channels. The first and third glass layers can be bonded to each side of the second glass layer to form the sheet 110, which includes the surface 115 and defines a mesh of interwoven channels, as shown in FIG. 4.

An additive manufacturing method can be implemented to create the sheet no in one contiguous unit or to create one or more sublayers. For example, the sheet 110 can be made with a two-laser (e.g., multi-photon) polymerization process in which an intersection of beams of light from each laser alter a base material, which can subsequently be washed away with a solvent. In another example, 3D-printing can be used to create the contiguous sheet 110 or each independent sublayer. However, the layer can be composed of any other material or combination of materials, can be of any other form or geometry, and can be manufactured in any other suitable way. For example, the sheet 110 can be made of a substantially transparent silicate.

The channels can be molded, machined, etched, or formed in the sheet 110 in any other suitable way. For example, the fluid channel can be a blind channel defined within the sheet 110. The sheet 110 can include a first sublayer and a second sublayer that, when joined, cooperate to define and to enclose the fluid channel. The first sublayer can define the attachment surface 115, and the fluid conduit can pass through the first sublayer to the attachment surface 115. In this variation, the first and second sublayers, can be of the same or similar materials, such as PMMA for both sublayers or surface-treated PMMA for the first sublayer and standard PMMA for the second sublayer. The channel can also be created by forming (or cutting, stamping, casting, etc.) an open channel in the first sublayer of the sheet 110 and then enclosing the channel with a second sublayer (without a channel feature) to form the enclosed channel and the sheet 110. Alternatively, the sheet 110 can include two sublayers, including a first sublayer defining an upper open channel section and including a second sublayer defining a lower open channel that cooperates with the upper open channel to define the channel when the first and second sublayers are aligned and joined. For example, each sublayer can include a semi-circular open channel, wherein, when bonded together, the sublayers form an enclosed fluid channel with a circular cross-section. However, the sheet 110 can define a fluid channel of any suitable cross-section, such as square, rectangular, circular, semi-circular, ovular, etc.

### 3. Electrically-Conductive Fluid

The touch sensor 100 also includes a set of distinct volumes of electrically-conductive fluid 120 contained within the set of channels. Generally, the electrically-conductive fluid 120 communicates an electric field across a portion of the sheet 110, such as between cavities, pads, or spikes of the first subset of channels and cavities pads, or spikes of the second subset of channels 144.

The channels can be filled with the set of distinct volumes of the electrically-conductive fluid 120. The electrically-conductive fluid can be saline, such as a solution of salt (e.g., sodium chloride, calcium chloride, sulfuric acid) in water or a solution of salt in vinegar. The electrically-conductive fluid can include a fluid with suspended ionic or conductive particulate in the fluid. For example, the electrically-conductive fluid 120 can include indium tin oxide (ITO) particulate suspended in mineral oil, a magnetorheological fluid, or a ferrofluid. However, the electrically-conductive can be any other suitable type of fluid including any other suitable ions, ionic particulate, or conductive particulate, such that the electrically-conductive fluid 120 can communicate an electric field across a portion of the layer. For example, the electrically-conductive fluid 120 in the set of distinct volumes can be saturated sodium chloride salt water. The fluid can also be hydrophilic, oleophilic, or have any other attractive properties such that the fluid is attracted to material of the sheet 110 and fills into small crevices (e.g., a point of a spike 149) in the channel(s) and cavities. Thus, the fluid can wick into sharp corners and/or narrow voids within the sheet to yield a controlled and repeatable electric field across a portion of the sheet 110 and to yield sufficient capacitive coupling between adjacent pads and/or spikes to enable detection of an input on the surface 115.

The electrically-conductive fluid 120 and the sheet 110 can be substantially optically transparent or translucent (e.g., clear) such that light can be transmitted through the touch screen. The electrically-conductive fluid 120 and the sheet 110 can be of substantially similar optical indices of refraction, such that a boundary between electrically-conductive fluid 120 and a channel is substantially optically indiscernible to a user. The cross-section of each channel can also omit or avoid sharps, curves, faces, etc. that reduce optical clarity and/or are optically discernible by a user at any viewing distance. However, the electrically conductive fluid can be of any other type of fluid, the sheet 110 can be of any other material, and the sheet 110 can define channels of any other form or geometry to reduce optical distortion of light transmitted through the touch sensor 100. Alternatively, the electrically-conductive fluid 120 can be substantially opaque.

In one implementation, an additional substance, such as a particulate (e.g., a salt), powder, and/or another fluid can be added to the fluid, such that the additional substance substantially prevents or resists color changes of the fluid. Generally, the additional substance can function to maintain optical clarity and transparency of the fluid, such as for an application in which the touch sensor 100 is mounted over a display. For example, Sodium Iodide (NaI) can be added to an electrically-conductive fluid, such as mineral oil with suspended indium tin oxide (ITO) particles, to prevent the mineral oil and ITO mixture from turning yellow and/or brown over time.

In another implementation, the set of distinct volumes of electrically-conductive fluid 120 can define disparate and independent volumes of electrically-conductive fluid 120, such that a volume of electrically-conductive fluid 120 in one channel is isolated and fluidly decoupled from a volume of electrically-conductive fluid 120 in another channel (e.g., an adjacent channel). However, a distinct volume of electrically-conductive fluid 120 contained within a channel can be capacitively coupled to a second distinct volume of electrically-conductive fluid 120 in a second channel. In this implementation, a distinct volume of electrically-conductive fluid 120 contained in one channel in the first subset of channels 142 can be of a different fluid type or mixture than a second distinct volume of electrically-conductive fluid 120 contained in a second channel in the second subset of channels 144. For example, a first channel in the first subset of channels 142 can contain a volume of saturated sodium chloride salt water. A second channel in the second subset of channels 144 and adjacent the first channel can contain a volume of a mixture of mineral oil and indium tin oxide (ITO). Likewise, a distinct volume of electrically-conductive fluid 120 contained in one channel in a particular subset of channels can be of a different fluid type or mixture than a distinct volume of fluid contained in a second channel in the particular subset of channels. For example, a first channel in the first subset of channels 142 can contain a volume of saturated sodium chloride salt water. A second channel in the first subset of channels 142 can contain a different fluid, such as a mixture mineral oil and indium tin oxide (ITO). Alternatively, the set of distinct volumes can be of the same fluid type. In this implementation, boundaries defined in the sheet 110 by walls of the channels isolate each distinct volume of fluid in the set of distinct volumes of fluid. Thus, the walls of the each channel can enclose and contain the each distinct volume of fluid, such that fluid in one channel cannot flow into an adjacent channel. Thus, the distinct volume of fluid defines a distinct, conductive array that, when a controller 150 applies a voltage pulse to the distinct volume of fluid, conducts the voltage pulse throughout the distinct volume of fluid. Furthermore, insulating material of the sheet 110 surrounding the channel contains the voltage pulse within each distinct volume of fluid. However, the distinct volumes of fluid in the set of distinct volumes of fluid can be capacitively coupled to each other through the cavities defined in the sheet 110 and inline with the channels.

The distinct volumes of fluid can be static or dynamic within the channels. For example, a peristaltic or any other pump can fluidly couple to a channel in the set of channels, such that the pump can displace (e.g., circulate) fluid within the channel. The pump can function to aid thermal transfer between the electrically-conductive fluid 120, the sheet 110, and ambient conditions. Alternatively, the fluid can be substantially static.

In another implementation, the electrically-conductive fluid 120 in the distinct volumes of fluid can be compressed to a higher pressure. In this implementation, the compressed fluid can function to increase electrical conductivity of the fluid by increasing density of the fluid and, thus, concentration of electrically-conductive ions within the fluid. For example, a user can apply pressure to the surface of the touch sensor, thereby increasing fluid pressure within the channels and, thus, the density of the electrically-conductive fluid contained therein. Therefore, sensitivity of the touch sensor can change dynamically as a user applies pressure to the surface 115, and the touch sensor 100 can thus become more sensitive to an input as the input is applied to the surface 115. In this example, the touch sensor can thus detect a magnitude of an input (e.g., a magnitude of force) applied to the surface 115.

In a similar implementation, the fluid can be expanded to a pressure lower than ambient pressure. For example, a pump fluidly coupled to a channel can evacuate fluid from the channel to lower the fluid pressure therein and, thus, decrease the temperature and/or alter the density (e.g., concentration) of conductive ions within the fluid. The touch sensor can also regulate temperature of the fluid to, for example, prevent overheating of the fluid within the touch sensor or to adjust a density of the fluid. Additionally, temperature of the fluid can be regulated to increase or decrease electronic activity to improve conductivity of the fluid. For example, the fluid can be heated to a higher temperature to increase electronic activity and, thus, increase the strength of the electric field, or the fluid can be cooled to reduce electrical resistance through a channel.

Based on the electrical conductivity of the electrically-conductive fluid 120, the minimum cross-sectional area of each channel in the first subset of channels 142 and second subset of channels 144 can be balanced with power availability (e.g., continuous voltage, energy capacity) to enable detection of a change in capacitance (e.g., the electric field) proximal a junction of two fluid channels. The change in capacitance can be correlated with contact by a foreign (input) object on the surface 115. For example, for a same power setting and controller 150, a first conductive fluid with a first electrical conductivity can require a greater minimum channel cross-sectional area that a second conductive fluid with a second electrical conductivity greater than the first. In another example, for a same fluid, a first system can apply a lower voltage across the electrically-conductive fluid 120 within the channels. However, fluid conductivity, channel cross-sectional area, and power requirements for the touch sensor 100 can be balanced, adjusted, or optimized in any other way.

### 4. Electrodes

The touch sensor 100 includes a set of electrodes 130 electrically coupled to the set of distinct volumes of electrically-conductive fluid 120. Generally, each electrode in the set of electrodes 130 contacts a channel and, thus, a distinct volume of electrically-conductive fluid 120. Each electrode in the set of electrodes 130 can electrically couple the volume of electrically-conductive fluid 120 in a channel to a controller 150 (or processor or conditioning circuit) and can transmit a voltage (or current) from a voltage (or current) source to a channel. Thus, the electrode functions to generate an electric field across a portion of the sheet 110 by coupling channels to a voltage (or current) source.

In one implementation shown in FIG. 1, each electrode in the set of electrodes 130 can include a metallic (e.g., copper) or otherwise conductive pin that pierces through the sheet 110 into a channel to electrically couple an external voltage (or current) source to the electrically-conductive volume of fluid within the channel. In a similar implementation shown in FIG. 3C, the set of electrodes 130 can include a first set of traces of electrically-conductive material arranged between the substrate and the first cover layer and a second set of traces of electrically-conductive material arranged between the substrate and the second cover layer, the first set of traces intersecting the first subset of channels 142, the second set of traces intersecting the second subset of channels 144. For example, a sublayer of the sheet 110 can include printed conductive traces, such as copper and ITO traces, that define the electrodes 130, wherein each printed trace aligns with a channel and contacts the electrically-conductive fluid 120 contained within the channel. In another implementation shown in FIG. 5, each channel can be open at a portion of the channel (e.g., at a side face perpendicular the surface 115 or the back surface 115 of the layer opposite the surface 115). Each electrode can define a metallic or otherwise conductive plug inserted into the fluid channel proximal the opening. However, each electrode in the set of electrodes 130 can electrically coupled to the fluid in one or more channels in any other way. In another implementation, the set of electrodes 130 can include a set of conductive wires, each conductive wires in the set of conductive wires piercing the sheet 110 and extending into a correspond channel in the set of channels. In another implementation, the channel can be lined with electrically conductive material, such as indium tin oxide or copper sheet, and, thus, the boundary of the channel itself can act as the electrode.

In another implementation, the electrodes 130 in the set of electrodes 130 can be of substantially transparent material. For example, in the implementation in which the touch sensor 100 is arranged over a display, the electrodes 130 can be integrated the touch sensor 100 such that the electrodes 130 are arranged over a portion of the display. The electrodes 130 can of a substantially transparent material, such as silver nanowire, in order to avoid optical interference across the touch sensor 100. Alternatively, the electrodes 130 can be substantially translucent or opaque. Thus, the electrodes 130 can be connected to the channels at an edge of the touch sensor 100 such, when the touch sensor 100 is arranged over a display, the opaque electrodes 130 are off screen and avoid optical interference.

### 5. Controller

One variation of the touch sensor 100 includes a controller 150 electrically coupled to the set of electrodes 130, applying a voltage to a subset of the set of distinct volumes of electrically-conductive fluid 120 contained in a subset of channels in the set of channels via a subset of the set of electrodes 130; and approximating a position of an input over the surface based on a change in voltage. Generally, the controller 150 generates an electric field across a portion of the sheet 110 by emitting, from a voltage (or current source), a voltage (or current) pulse through the electrodes 130 into the channel and capturing changes in the electric field across the portion of the sheet 110 by monitoring the capacitance across the channels in the set of channels. Thus, the controller 150 controls both the electric field across the sheet 110 and detects changes in the electric field (e.g., through mutual capacitance) across the sheet 110 via the electrodes 130 electrically coupled to the fluid in the channels. The controller 150 can correlate changes in the electric field across portions of the sheet 110 with the presence and location of an input on the surface, such as provided by a finger or stylus in contact with or proximal the surface. For example, the controller 150 can identify a touch, tap, resting finger, or other singular input selection on the surface. The controller 150 can also correlate multiple simultaneous inputs on the surface and/or changes in the position of one or more inputs on the surface over time with a gesture input on the surface. For example, the controller 150 can identify a swipe, pinch, scroll, or expansion gesture applied to the surface.

The controller 150 can implement input analysis and gesture recognition techniques. The controller 150 can also account for temperature, barometric, hysteresis, multiple simultaneous inputs, etc. when correlating electric field (e.g., mutual capacitance) changes across portions of the sheet 110 with the presence and location of an input on the surface 115. However, the controller 150 can function in any other way to capture, analyze, and identify one or more inputs and/or gestures on the surface 115 of the sheet 110.

In one implementation, the controller 150 can set the first channel as a transmitter, set the second channel as a receiver, apply a voltage pulse to the first channel via a corresponding first electrode in the set of electrodes 130, record a discharge time of the voltage pulse at the second channel via a corresponding second electrode in the set of electrodes 130, and approximate the position of an input over the surface 115 adjacent the first cavity 148 and the second cavity 148 based on the discharge time of the voltage pulse. Thus, the controller 150 can detect an input on the surface 115 by implementing mutual capacitance touch sensor techniques.

In an example of the foregoing implementation, the controller 150 can approximate the position of the input over the surface 115 proximal a confluence of the first channel and the second channel based on the discharge time of the voltage pulse. Generally, the controller 150 can detect a baseline time of discharge for the voltage pulse corresponding to the absence of an input proximal the surface. Since the voltage pulse discharges through the confluence (e.g., the pad or spike) to the input object when the input object is proximal the surface, the time of discharge for the voltage pulse when the input object is proximal the surface will be shorter than the baseline time of discharge. Variation between the baseline time of discharge and detected time of discharge can be interpreted as an input by the controller 150.

Likewise, the controller 150 can interpret the location of the input by detecting which electrodes of the array of electrodes experiences a shortened (or otherwise altered) discharge time for an applied voltage. In an implementation in which the arrays of channels form a mesh, the controller 150 can define one array of the mesh as a first axis and the second array of the mesh as a second axis. Thus, the mesh can define a coordinate system of channels from which the controller 150 can detect a two-dimensional location of an input on the surface. Furthermore, in this implementation, the controller 150 can detect locations of multiple inputs to the surface 115.

In another implementation, the controller 150 can selectively apply a voltage to each electrode in the set of electrodes 130 sequentially, record a time to a voltage threshold for each electrode in the set of electrodes 130, and approximate the position of an input over the surface 115 based on a comparison between a baseline time and the time to reach the voltage threshold for each electrode in the set of electrodes 130. Thus, the controller 150 can detect an input on the surface 115 by implementing self capacitive touch sensor techniques. Generally, in a single sensor sampling period the controller 150 sequentially applies a voltage to each electrode in the electrode array 130, reads voltage rises and/or fall times for each electrode, and makes a final determination of a location of an input on the surface 115 once rise and/or fall times are detected for every electrode in the array in the sensor sampling period.

In an example of the foregoing implementation, the controller 150 can record a decay time (e.g., from a voltage high threshold (e.g., +0.3V) to a voltage low threshold (e.g., −0.3V)) for each electrode in the set of electrodes 130 and approximate the position of the input based on a comparison between a baseline time and the decay time from the voltage threshold for each electrode in the set of electrodes 130. Generally, the controller 150 can apply an oscillating voltage signal through a capacitive sensing module to an electrode, wherein other electrodes in the set of electrodes are grounded. The controller can measure a baseline time for the controller to cycle through a defined number of cycles of the oscillating voltage signal from capacitive sensing module, the baseline time corresponding to the absence of an input proximal the surface. The controller 150 can also apply the oscillating voltage signal at the selected electrode and compare a detected time for the controller to cycle through the defined number of cycles of the oscillating voltage signal from the capacitive sensing module to the baseline time to detect presence or absence of an input on an adjacent region of the surface 115. Since voltage discharges through the confluence (e.g., the pad or spike) to the input object when the input object is proximal the surface, frequency of the oscillating voltage signal changes when the input object is proximal the surface. Thus, the detected time required for the controller to cycle through the defined number of cycles changes when an input object is proximal the surface. The controller can thus interpret a variation between a baseline time and a detected time for an electrode as an input on an adjacent region of the surface 115.

However, the controller 150 can function in any other suitable way to detect one or more inputs at the surface 115.

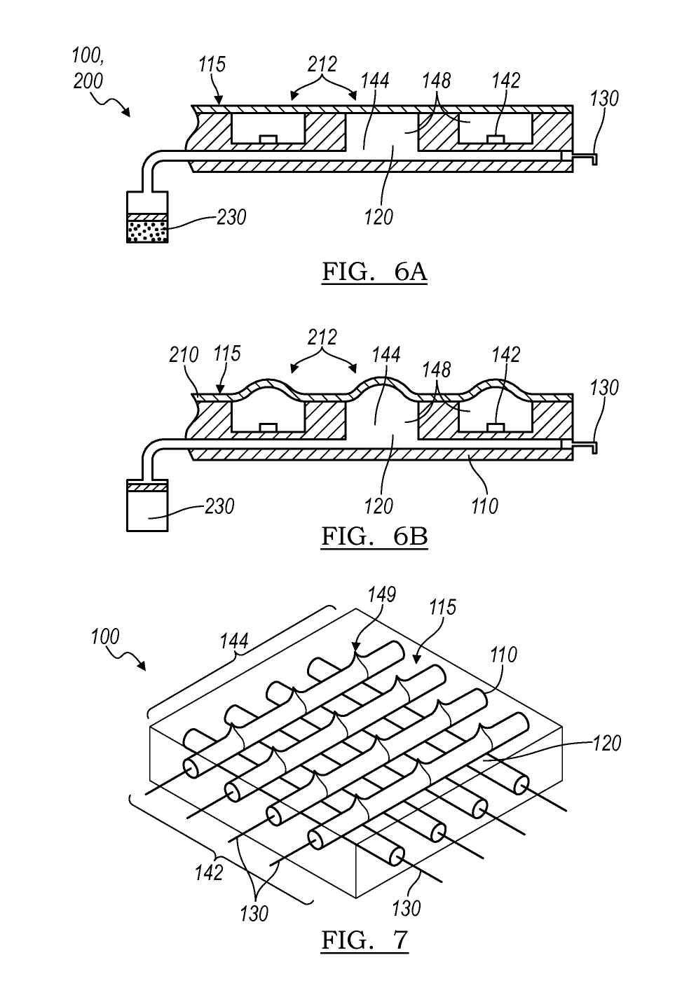

In one variation of the touch sensor 100 shown in FIGS. 6A and 6B, the sheet 110 includes a substrate and a tactile layer 210 that defines the surface 115, wherein a channel in either the first subset of channels 142 or the second subset of channels 144 and integrated in the sheet is fluidly coupled to a displacement device 230, and wherein the displacement device 230 displaces conductive fluid through a channel to outwardly expand a portion of the tactile layer 210 into a tactilely distinguishable formation at the surface 115 of the sheet 110. Generally, the touch sensor 100 can implement the user interface of U.S. patent application Ser. No. 14/317,685, which is incorporated in its entirety by this reference. In this variation, the conductive fluid contained within the channels functions to communicate an electric field across a portion of the layer, to communicate changes in the electric field to a controller 150, and to transmit pressure from a displacement device 230 to the tactile layer 210 to transition the tactile layer 210 between tactilely distinguishable expanded and retracted settings, as shown in FIGS. 6B and 6A respectively.

In one implementation of the variation of the sheet 110, the sheet 110 can also include a substrate and a tactile layer 210, the tactile layer 210 including a peripheral region coupled to the substrate and a deformable region 212 adjacent the peripheral region and arranged over a particular channel in the set of channels; and further including a displacement device 230 (e.g., a pump) displacing fluid into the particular channel to transition the deformable region 212 from a retracted setting into an expanded setting, the deformable region 212 substantially flush with the peripheral region in the retracted setting, and the deformable region 212 defining a formation tactilely distinguishable from the peripheral region in the expanded setting. Generally, the tactile layer 210 functions to define one or more deformable regions arranged over a corresponding perforation, such that displacement of fluid into and out of the perforations (i.e., via the fluid channel) causes the deformable region 212(s) to expand into the expanded setting and to retract into the retracted setting. Thus, the tactile layer 210 yields a flush surface in the retracted setting and a tactilely distinguishable surface in the expanded setting. The tactile layer 210 can be attached to the substrate across the peripheral region and/or along a periphery of the peripheral region and adjacent or around the deformable region 212. The tactile layer 210 can be bonded to the substrate at all points across the peripheral region or can be bonded at an area adjacent the deformable region 212. For example, the tactile layer 210 can be bonded (e.g., adhered, welded, etc.) to the substrate at any or all points circumferentially surrounding the deformable region 212 with a circular periphery. Alternatively, a portion of the tactile layer 210 can be bonded to the substrate along the periphery of the deformable region 212. For example, the tactile layer 210 can be bonded to the substrate along one side of the deformable region 212 with a substantially rectangular periphery. Three remaining sides of the rectangular periphery can be unbounded from the substrate. The deformable region 212 can be substantially flush with the peripheral region in the retracted setting and expanded above the peripheral region (e.g., offset vertically above the peripheral region) in the expanded setting.

In a similar variation, the sheet 110 of the touch sensor 100 can be implemented as a tactile layer 210 of a dynamic tactile layer 200, such as described in U.S. patent application Ser. No. 13/481,676, which is incorporated in its entirety by this reference. The dynamic tactile layer 200 includes a substrate and the touch sensor 100, the touch sensor 100 further including a peripheral region coupled to the substrate and a deformable region 212 adjacent the peripheral region and arranged over a fluid channel defined by the substrate; and further including a displacement device 230 displacing fluid into the particular channel to transition the deformable region 212 from a retracted setting into an expanded setting, the deformable region 212 substantially flush with the peripheral region in the retracted setting, and the deformable region 212 defining a formation tactilely distinguishable from the peripheral region in the expanded setting. In this variation, the sheet 110 can be flexible, thus enabling deformation of the sheet 110 between the expanded and retracted settings at a deformable region 212. The sheet 110 can include a channel across the deformable region 212 of the sheet 110, such that inputs at the deformable region 212 can be captured in both the expanded setting and the retracted setting. Furthermore, the electrically-conductive fluid 120 in the touch sensor 100 can be isolated from fluid in the dynamic tactile layer 200 used to transition the deformable region 212(s) between expanded and retracted settings. The fluid in the dynamic tactile layer 200 can be non-conductive. Alternatively, the fluid in the dynamic tactile layer 200 can be conductive, such that the fluid in the dynamic tactile layer 200 can interact with the electric field communicated by the electrically-conductive fluid 120 in the touch sensor 100 to improve the sensitivity and/or accuracy of the touch sensor 100.

In the foregoing variations, the controller 150 can also account for the position of the sheet 110 at one or more deformable regions when analyzing the change in the electric field across one or more portions of the sheet 110, as described in U.S. Patent Application No. 61/705,053.

The systems and methods of the preceding embodiments can be embodied and/or implemented at least in part as a machine configured to receive a computer-readable medium storing computer-readable instructions. The instructions can be executed by computer-executable components integrated with the application, applet, host, server, network, website, communication service, communication interface, native application, frame, iframe, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention defined in the following claims.

I claim:

1. A touch sensor comprising:
a sheet defining a surface and enclosing a set of channels, each channel in the set of channels isolated from other channels in the set of channels and defining a variable width;
a set of distinct volumes of electrically-conductive fluid contained within the set of channels;
a set of electrodes electrically coupled to the set of distinct volumes of electrically-conductive fluid; and
a controller electrically coupled to the set of electrodes, applying a voltage to a subset of the set of distinct volumes of electrically-conductive fluid contained in a subset of channels in the set of channels via a subset of the set of electrodes; and approximating a position of an input over the surface based on a change in voltage.

2. The touch sensor of claim 1, wherein the sheet encloses a first subset of channels in the set of channels at a first depth below the surface and encloses a second subset of channels in the set of channels at a second depth below the surface greater than first depth, the first subset of channels defining a first linear array; and the second subset of channels defining a second linear array.

3. The touch sensor of claim 2, wherein the first linear array is substantially perpendicular to the second linear array.

4. The touch sensor of claim 2, wherein each channel in the set of channels comprises a series of cavities of a first width interposed between neck sections of a second width less than the first width.

5. The touch sensor of claim 4, wherein the first subset of channels comprises cavities interleaved between cavities of the second subset of channels; and wherein the first subset of channels comprises neck sections arranged over neck sections of the second subset of channels.

6. The touch sensor of claim 5, wherein a first cavity of a first channel in the first subset of channels is capacitively coupled to a second cavity of a second channel in the second subset of channels adjacent the first cavity; and wherein the controller sets the first channel as a transmitter, sets the second channel as a receiver, applies a voltage pulse to the first channel via a corresponding first electrode in the set of electrodes, records a discharge time of the voltage pulse at the second channel via a corresponding second electrode in the set of electrodes, and approximates the position of the input over the surface adjacent the first cavity and the second cavity based on the discharge time of the voltage pulse.

7. The touch sensor of claim 4, wherein the first subset of channels comprises cavities defining a first set of planar faces adjacent and offset from the surface; and wherein the second subset of channels comprises cavities defining a second set of planar faces substantially in plane with the first set of planar faces.

8. The touch sensor of claim 1, wherein the sheet comprises a substrate, a first cover layer defining the surface and arranged over a first face of the substrate to enclose a first subset of channels in the set of channels; and a second cover layer arranged over a second face of the substrate opposite the first face to enclose a second subset of channels in the set of channels; wherein the set of electrodes comprises a first set of traces of electrically-conductive material arranged between the substrate and the first cover layer and a second set of traces of electrically-conductive material arranged between the substrate and the second cover layer, the first set of traces intersecting the first subset of channels, the second set of traces intersecting the second subset of channels.

9. The touch sensor of claim 1, wherein the set of distinct volumes of electrically-conductive fluid comprises a substantially transparent electrically-conductive fluid; and wherein the sheet comprises a substantially transparent elastic material, the sheet substantially flexible across the surface.

10. The touch sensor of claim 1, wherein the controller selectively applies a voltage to each electrode in the set of electrodes sequentially, records a time to a voltage threshold for each electrode in the set of electrodes, and approximates the position of an input over the surface based on a comparison between a baseline time and the time to the voltage threshold for each electrode in the set of electrodes.

11. The touch sensor of claim 4, wherein the sheet comprises a substrate and a tactile layer, the a tactile layer comprising a peripheral region coupled to the substrate and a deformable region adjacent the peripheral region and arranged over a particular channel in the set of channels; and further comprising a displacement device displacing fluid into the particular channel to transition the deformable region from a retracted setting into an expanded setting, the deformable region substantially flush with the peripheral region in the retracted setting, and the deformable region defining a formation tactilely distinguishable from the peripheral region in the expanded setting.

12. The touch sensor of claim 1, wherein the set of electrodes comprises a set of conductive wires, each conductive wires in the set of conductive wires piercing the sheet and extending into a correspond channel in the set of channels.

13. A touch sensor comprising:
a sheet defining a surface and enclosing a set of channels, each channel in the set of channels distinct from other channels in the set of channels and comprising a series of cavities of first width interposed between neck sections of a second width less than the first width, a projection of a first subset of channels in the set of channels onto the surface intersecting a projection of a second subset of channels in the set of channels onto the surface;
a set of distinct volumes of electrically-conductive fluid contained within the set of channels, fluid contained within a cavity of a channel in the first subset of channels capacitively coupled to fluid contained within a cavity of a channel in the second subset of channels; and
a set of electrodes, an electrode in the set of electrodes electrically coupled a distinct volume of electrically-conductive fluid in the set of distinct volumes of electrically-conductive fluid.

14. The touch sensor of claim 13, wherein the first subset of channels comprises cavities interleaved between cavities of the second subset of channels; and wherein the first subset of channels comprises neck sections arranged over neck sections of the second subset of channels.

15. The touch sensor of claim 14, wherein a channel in the first subset of channels comprises a first cavity and a first neck section adjacent the first cavity, the first cavity of a first cross-sectional area, the first neck section of a second cross-sectional approximating the first cross sectional area.

16. The touch sensor of claim 13, wherein the sheet encloses channels in the first subset of channels along a first linear direction and at an oscillating depth from surface, and wherein the sheet encloses channels in the second subset of channels along a second linear direction nonparallel to the first linear direction and at an oscillating depth from surface, the set of channels comprising the series of cavities proximal inflection points along the first subset of channels and the second subset of channels adjacent the surface.

17. The touch sensor of claim 13, further comprising a controller coupled to the set of electrodes, setting a first channel in the first subset of channels as a transmitter, setting a second channel in the second subset of channels as a receiver, applying a voltage pulse to a the first channel via a corresponding first electrode in the set of electrodes, recording a discharge time of the voltage pulse at the second channel via a corresponding second electrode in the set of electrodes, and approximating a position of an input over the surface adjacent proximal a confluence of the first channel and the second channel based on the discharge time of the voltage pulse.

18. The touch sensor of claim 13, further comprising a controller coupled to the set of electrodes, selectively applying a voltage to each electrodes in the set of electrodes sequentially, recording a decay time from a voltage threshold for each electrode in the set of electrodes, and approximating a position of an input over the surface based on a comparison between a baseline time and the decay time from the voltage threshold for each electrode in the set of electrodes.

19. The touch sensor of claim 13, wherein the sheet comprises a substantially transparent silicate, and wherein each distinct volume of electrically-conductive fluid in the set of distinct volumes of electrically-conductive fluid comprises saturated sodium chloride salt water.

20. A touch sensor comprising:
a sheet defining a surface, a first array of channels; and a second array of channels, the sheet enclosing channels in the first array of channels at a first depth below the surface, the sheet enclosing channels in the second array of channels at a second depth from the surface greater than the first depth, a projection of the first array of channels onto the surface intersecting a projection of the second array of channels onto the surface;
a first set of discrete volumes of electrically-conductive fluid, a discrete volume of electrically-conductive fluid in the first set of volumes of electrically-conductive fluid contained within a channel in the first array of channels;
a second set of discrete volumes of electrically-conductive fluid, a discrete volume of electrically-conductive fluid in the second set of volumes of electrically-conductive fluid contained within a channel in the second array of channels;
a first set of electrodes, an electrode in the first set of electrodes electrically coupled to a discrete volume of electrically-conductive fluid in the first set of volumes of electrically-conductive fluid, the first set of electrodes communicating electrical current into the first set of discrete volumes of electrically-conductive fluid;
a second set of electrodes, an electrode in the second set of electrodes electrically coupled to a discrete volume of electrically-conductive fluid in the second set of volumes of electrically-conductive fluid, the second set of electrodes communicating electrical current into the second set of discrete volumes of electrically-conductive fluid, the first set of discrete volumes of electrically-conductive fluid capacitively coupled to the second set of discrete volumes of electrically-conductive fluid.
